(19) United States
(12) Patent Application Publication
(10) Pub. No.: US 2020/0211415 A1
(43) Pub. Date: Jul. 2, 2020

(54) System For Performing Multiplication

(71) Applicant: Mohammad Gheith, Ocoee, FL (US)

(72) Inventor: Mohammad Gheith, Ocoee, FL (US)

(21) Appl. No.: 16/795,751

(22) Filed: Feb. 20, 2020

Related U.S. Application Data
(63) Continuation-in-part of application No. 15/635,186, filed on Jun. 27, 2017.

(51) Int. Cl. G09B 19/02; G09B 1/04

(52) U.S. Cl. CPC G09B 19/02; G09B 1/04

(57) ABSTRACT

A frame used atop a workbook page or looseleaf page that assists in computing a multiplication problem. The frame has various tools attached or adjacent thereto. Amongst these tools are a pivot point indicator, a column locator and a criss cross template for marking or analyzing the multiplication problem found in the multiplication zone of the multiplication problem. A method of using the frame in a typical multiplication problem with students is disclosed having a sequence of steps for computing the correct results thereof.

### CROSS-REFERENCE TO RELATED APPLICATIONS

This application is a continuation-in-part of U.S. non-provisional Ser. No. 14/269,124 filed on May 3, 2014, entitled “Method of Teaching Multiplication to Mathematics Students”. The '124 non-provisional application claimed priority benefits from U.S. provisional patent application Ser. No. 61/822,876 filed on May 13, 2013, entitled “Method of Teaching Multiplication to Mathematics Students”. Each of the '124 non-provisional application and the '876 provisional application is hereby incorporated by reference herein in its entirety.

### FIELD OF INVENTION

The present invention relates to the field of mathematics and, in particular, to a system for performing multiplication.

### BACKGROUND OF THE INVENTION

Individuals acquire analytical skills in different ways. For many individuals, traditional techniques for acquiring and performing mathematical skills, such as multiplication and division, are not as effective as other less conventional, and perhaps previously overlooked, techniques. It is therefore beneficial to have available a portfolio of techniques for acquiring and performing a given mathematical skill so that a individual having difficulty in acquiring the skill using one technique can turn to a different technique that may be better suited to each individual's way of learning and performing mathematical tasks.

In the case of multiplication of multi-digit numbers, the conventional technique involves arranging the digits in columns and keeping track of how many places to proceed to the left as multiplications of individual digits are performed. With larger multi-digit numbers, this conventional technique can get confusing as it is easy to lose track of how many places to the left to arrange the product of each of the two digits being multiplied. Carrying numbers can also be confusing because numbers arranged in columns at the top can get confused as multiple numbers are being carried and arranged on top of the same digit in the original number. Mistakes are also hard to find in this conventional technique when so many digits need to be carefully arranged in proper columns. Adding up the rows of digits at the end of the conventional technique is an extra step that can be subject to error as well.

The present system for performing multiplication provides an alternative approach to multiplying multi-digit numbers that can be understood by individuals who struggle with conventional multiplication techniques. The present system is particularly effective for performing multiplication of large multi-digit numbers.

### SUMMARY OF THE INVENTION

Shortcomings of conventional multiplication techniques are overcome by a system for performing multiplication of two multi-digit numbers. The system comprises:
(a) a surface configured to contain a work area, the work area capable of displaying diagrammatically arranged numerals, the work area comprising:
   (1) a Multiplication Zone configured to display the numerals arranged such that the digits of one number to be multiplied are vertically aligned with the digits of the other number to be multiplied;
   (2) an Addition Zone comprising a top row, a bottom row and a plurality of middle rows, the rows divided into a number of columns corresponding to the sum of the number of digits in the numbers to be multiplied minus one;
   (3) an Answer Zone comprising a row divided into a number of cells corresponding to the sum of the number of digits in the numbers to be multiplied minus one;
(b) a first pivot point indicator displayed beneath the aligned lowest place digits of the numbers to be multiplied displayed in the Multiplication Zone;
(c) first numerals displayed in the middle rows of the rightmost empty column of the Addition Zone, the first numerals corresponding to the results of multiplying the aligned lowest place digits and the results of cross-multiplication of the aligned digits on either side of the first pivot point indicator progressively in pairs until no further pairs can be formed;
(d) a second numeral displayed in the rightmost empty cell in the bottom row of the Addition Zone, the second numeral corresponding to the result of adding together by column the first numerals displayed in the middle rows of the Addition Zone;
(e) a third numeral displayed in the rightmost empty cell of the Answer Zone, the third numeral corresponding to the lowest place digit of the second numerals taken as a single multi-digit number;
(f) a fourth numeral displayed in the next cell to the left in the top row of the Addition Zone, the fourth numeral corresponding to the higher place digits of the second numerals taken as a single multi-digit number;
(g) a next pivot point indicator displayed in the work area between the aligned lowest and next-lowest place digits of the pair of multi-digit numbers to be multiplied in the Multiplication Zone;
(h) fifth numerals displayed in the middle rows of the rightmost empty column of the Addition Zone, the fifth numerals corresponding to the results of cross-multiplying the aligned digits on either side of the next pivot point indicator progressively in pairs until no further pairs can be formed;
(j) a sixth numeral displayed in the rightmost empty cell of the Answer Zone, the sixth numeral corresponding to the result of adding together by column the fifth numerals displayed in the middle rows of the Addition Zone
(k) a seventh numeral displayed in the rightmost empty cell of the Answer Zone, the seventh numeral corresponding to the lowest place digit of the fifth numerals taken as a single multi-digit number;
(l) an eighth numeral displayed in the next cell to the left in the top row of the Addition Zone, the eighth numeral corresponding to the higher place digits of the fifth numerals taken as a single multi-digit number;
(m) further numerals displayed in the Addition and Answer Zones of the work area in accordance with the arrangement of the first through eighth numerals, and first and next pivot point indicators, until the left-most aligned digits of the multi-digit numbers to be multiplied have all been multiplied;

In operation, the result of the multiplication of the pair of multi-digit numbers to be multiplied is displayed as the sequence of digits in the Answer Zone.

In the case of the multi-digit numbers having different lengths, the lengths are made equal by preceding the smaller number with zeroes.

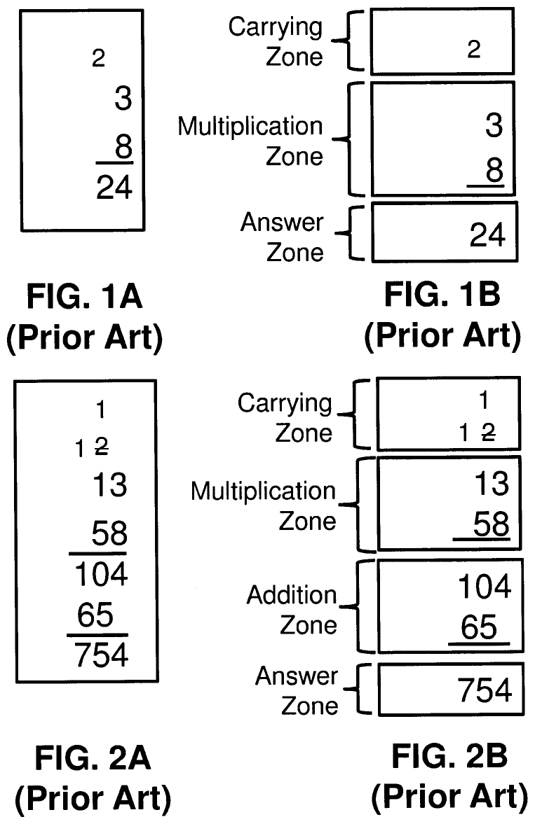

FIG. 1A (Prior Art) is a diagram depicting the conventional technique for multiplying two single digit numbers. FIG. 1B (Prior Art) is a diagram depicting the conventional technique for multiplying two single-digit numbers in which the work area is divided into zones to facilitate the carrying out of the technique.

FIG. 2A (Prior Art) is a diagram depicting the conventional technique for multiplying two double digit numbers. FIG. 2B (Prior Art) is a diagram depicting the conventional technique for multiplying two double digit numbers in which the work area is divided into zones to facilitate the carrying out of the technique.

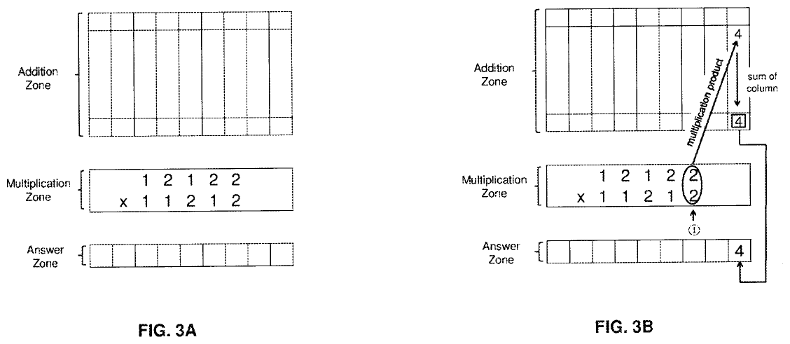

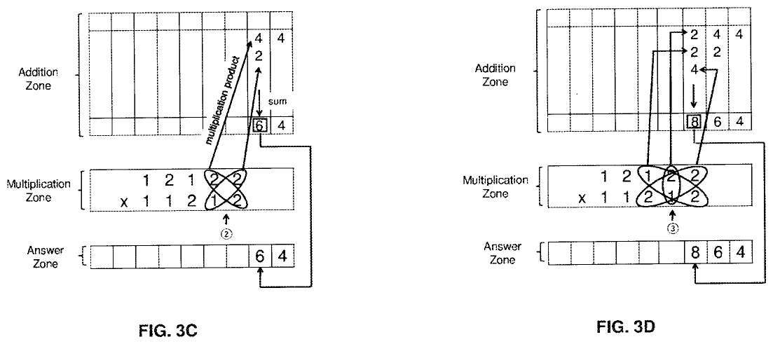

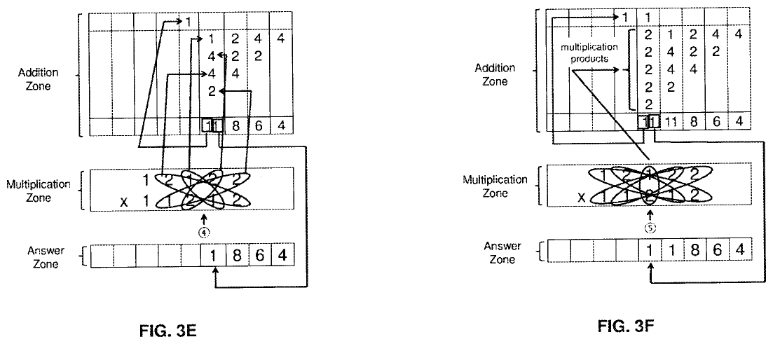

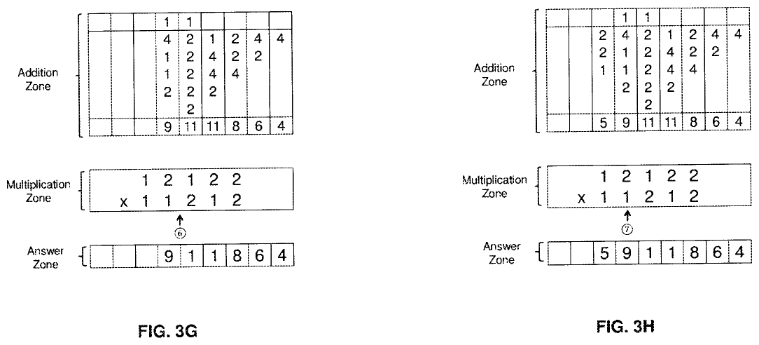

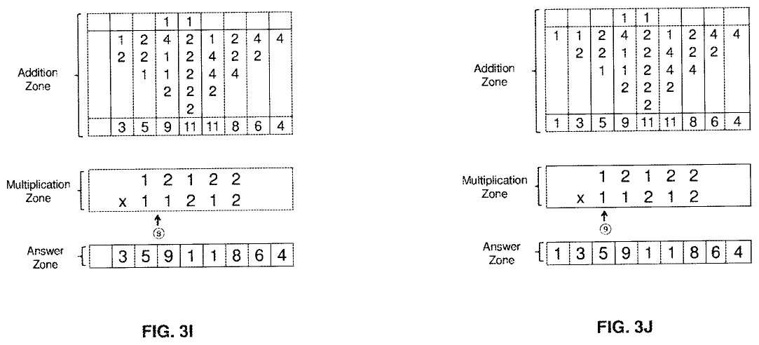

FIGS. 3A-3J are schematic diagrams of surfaces configured to contain a work area with displays associated with the present system for performing multiplication of two 5-digit numbers, made up of the digits 1 and 2 for simplicity, in which the work area is divided into zones to facilitate operation of the system.

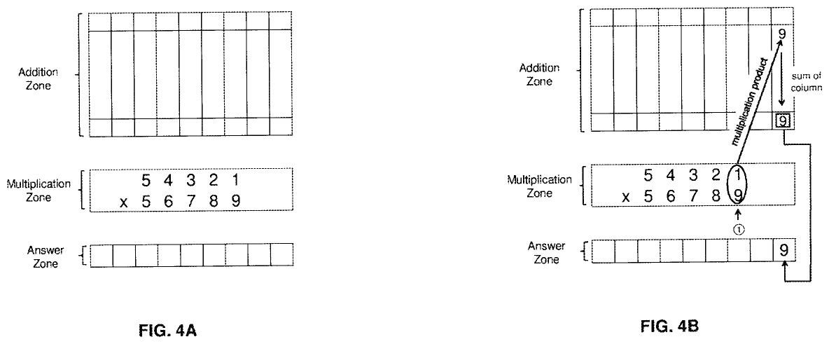

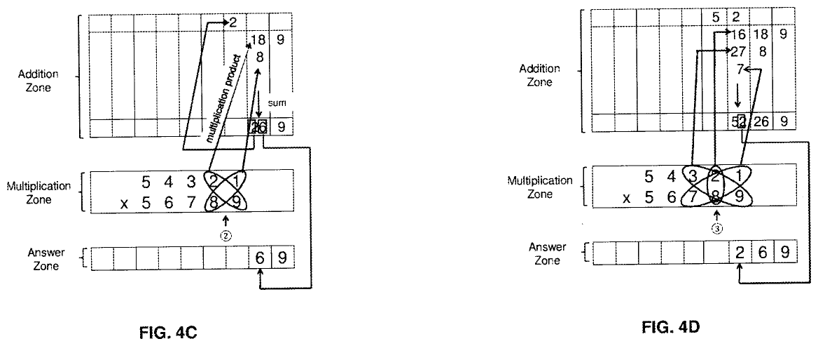

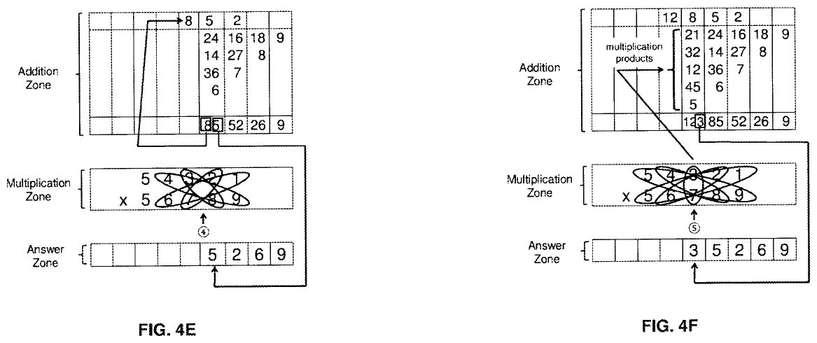

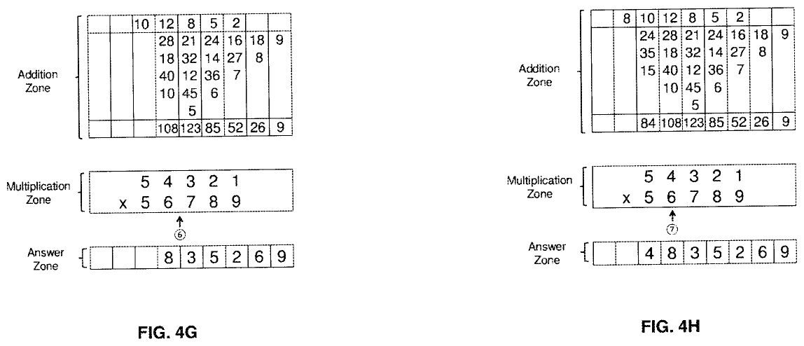

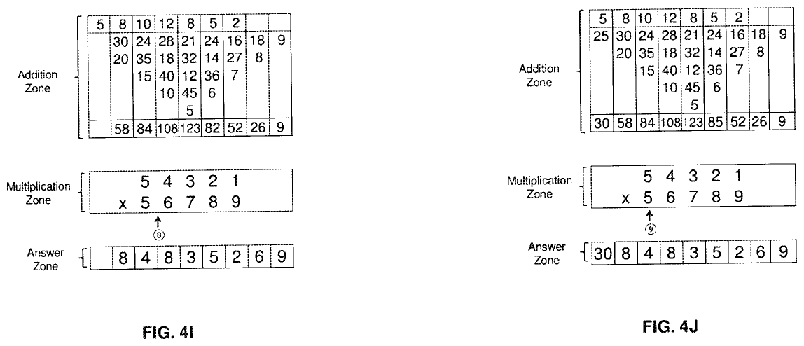

FIGS. 4A-4J are schematic diagrams of surfaces configured to contain a work area with displays associated with the present system for performing multiplication of two 5-digit numbers, made up of number larger than those in FIGS. 3A-3J, in order to demonstrate operation of the present system using more complex numbers.

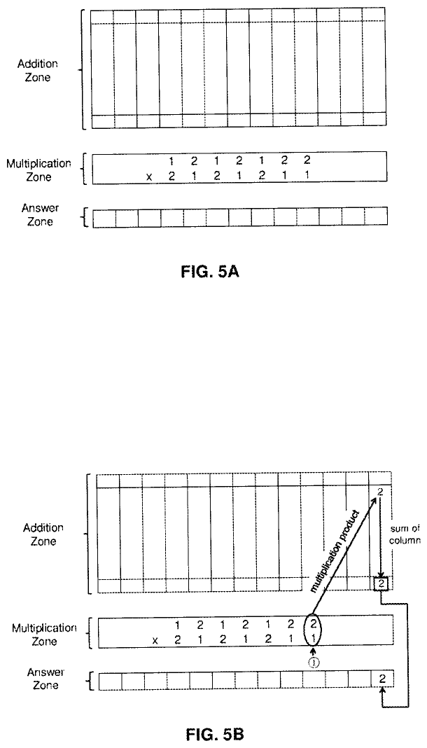

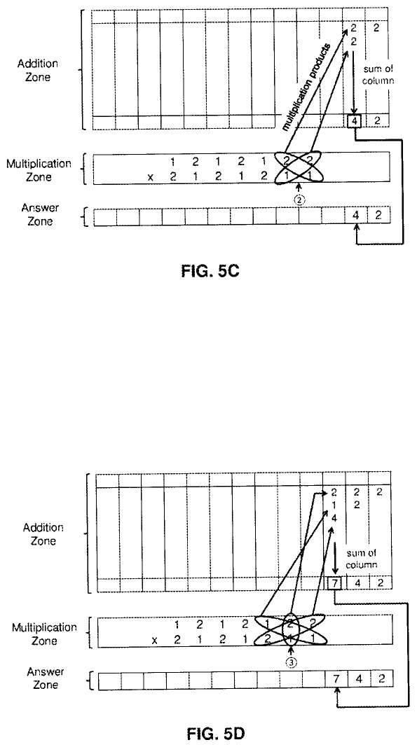

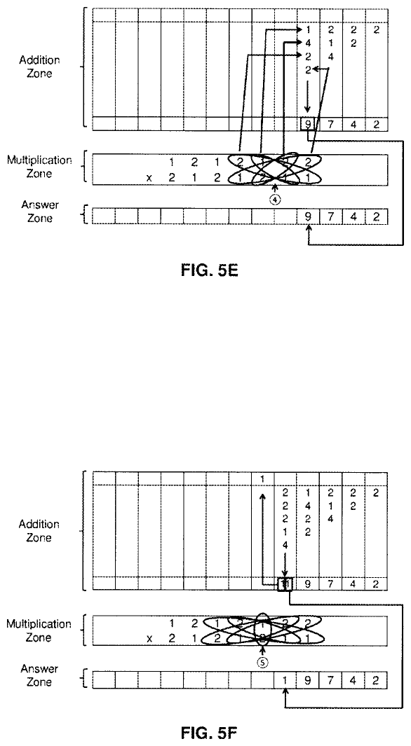

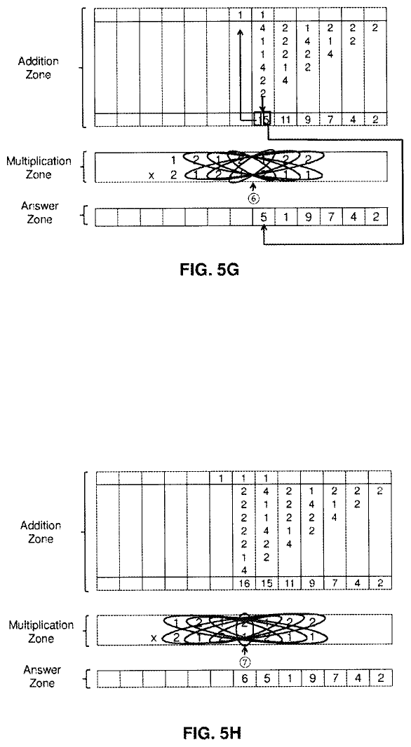

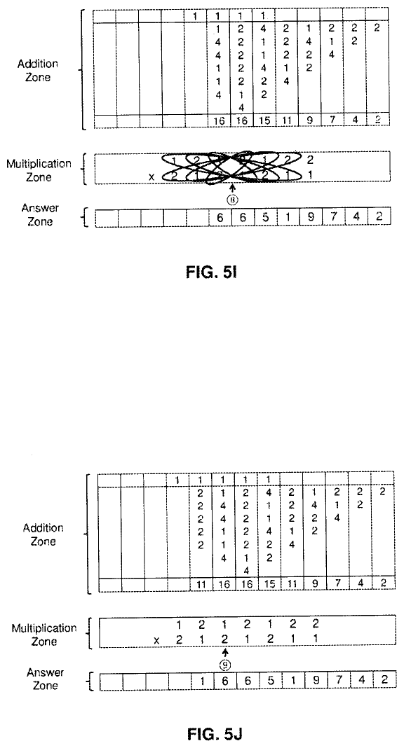

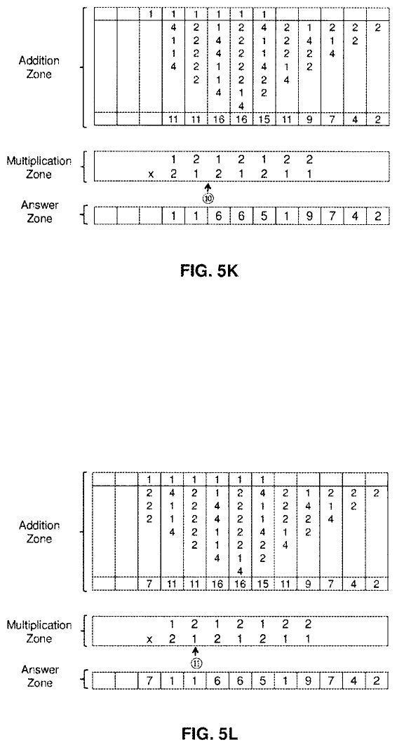

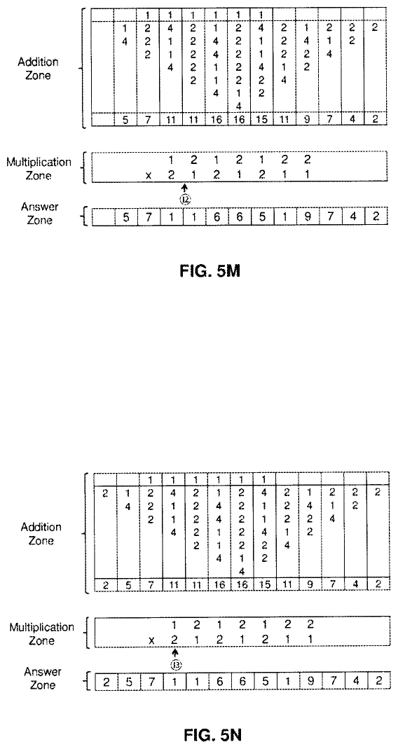

FIGS. 5A-5N are schematic diagrams of surfaces configured to contain a work area with displays associated with the present system for performing multiplication of two 7-digit numbers.

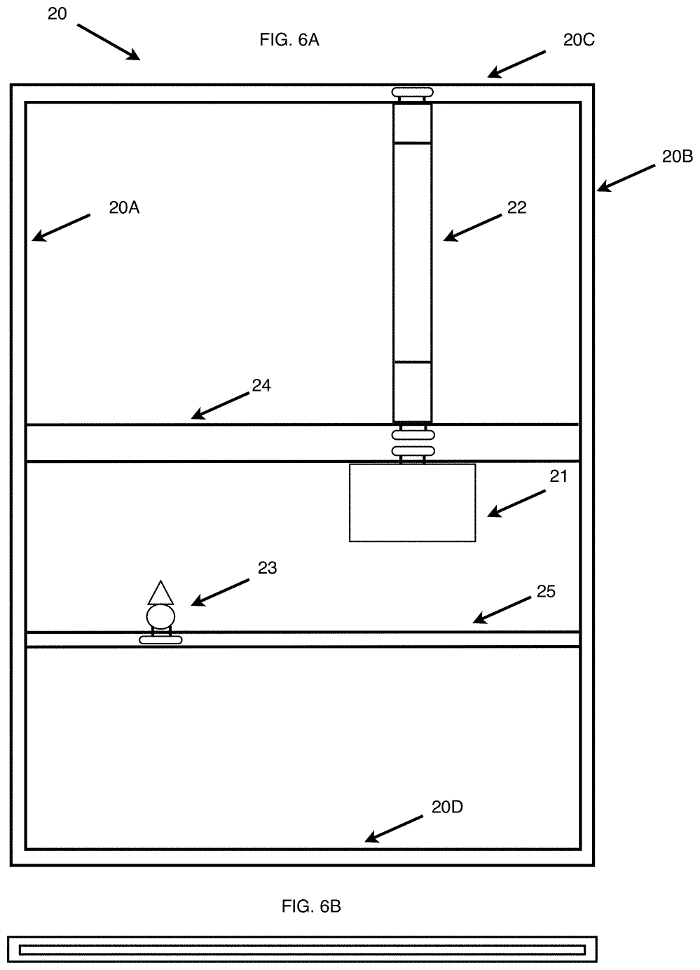

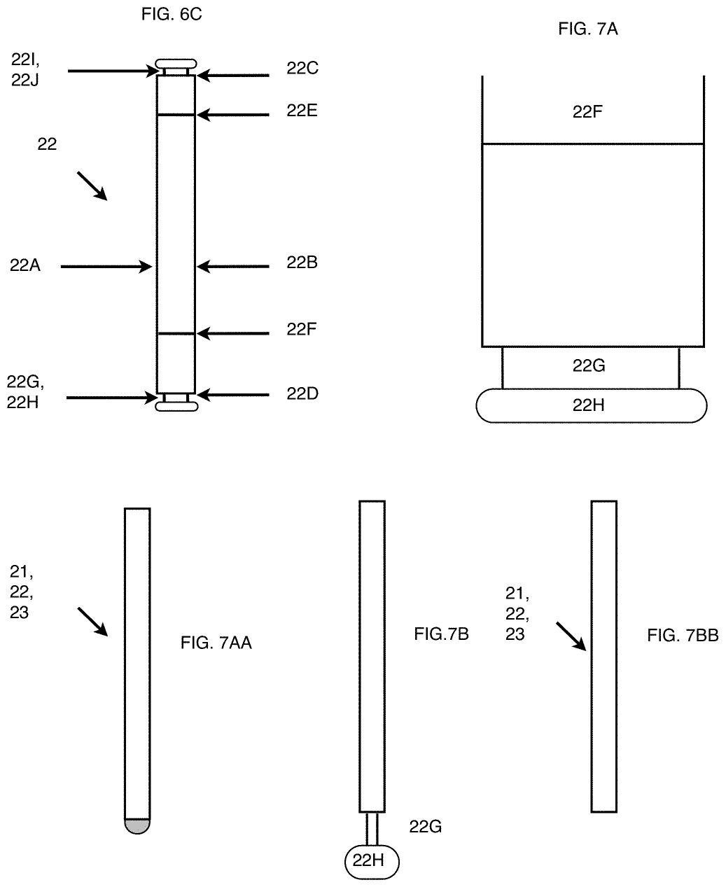

FIG. 6A presents a front view of a math learning frame and system in an embodiment disclosed herein. FIG. 6B presents a top (or bottom) view of transverse members 24, 25, primary member 20A, of the math learning frame and system in an embodiment disclosed herein having three surface options. FIG. 6C presents a front view of a column locator of the math learning frame and system in an embodiment disclosed herein.

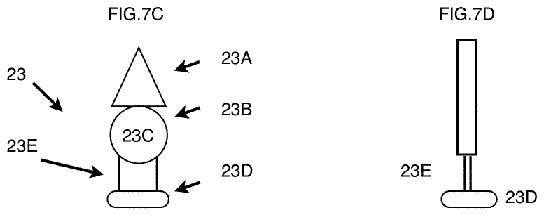

FIG. 7A presents a closeup front view of column locator bottom of the math learning frame and system in an embodiment disclosed herein. FIG. 7AA presents a closeup side view of an alternative column locator (or pivot point indicator bottom or template top) bottom of the math learning frame and system in an embodiment disclosed herein. FIG. 7B presents a closeup side view of a column locator bottom of the math learning frame and system in an embodiment disclosed herein. FIG. 7BB presents a closeup side view of an alternative column locator bottom of the math learning frame and system in an embodiment disclosed herein.

FIG. 7C presents a front view of a pivot point indicator of the math learning frame and system in an embodiment disclosed herein. FIG. 7D presents a side view of a pivot point indicator of the math learning frame and system in an embodiment disclosed herein.

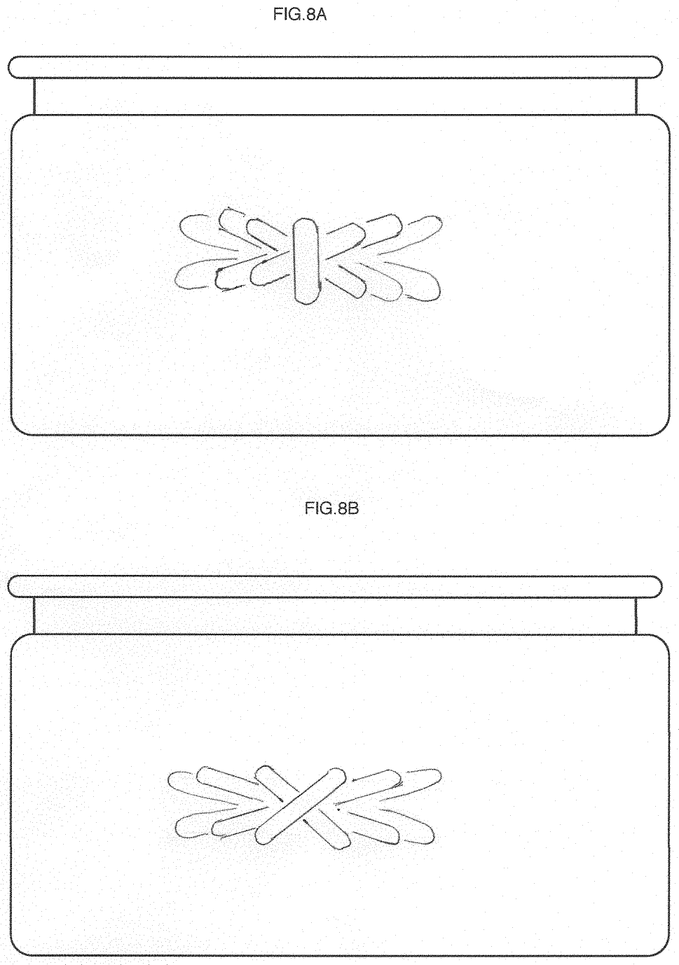

FIG. 8A presents a front view of a criss-cross template for odds of the math learning frame and system in an embodiment disclosed herein. FIG. 8B presents a front view of a criss-cross template for evens of the math learning frame and system in an embodiment disclosed herein.

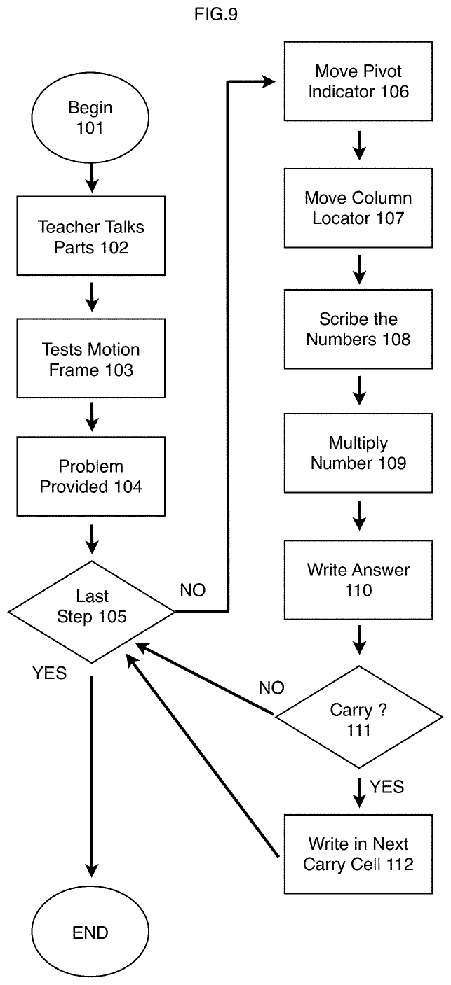

FIG. 9 presents a flowchart of the process by which a teacher instructs students in how to utilize the math learning frame and system in an embodiment disclosed herein.

### DETAILED DESCRIPTION OF PREFERRED EMBODIMENT(S)

Turning first to FIG. 1A, the conventional technique for performing multiplication involves first arranging the digits of the numbers to be multiplied in columnar fashion with a line drawn beneath the lower number. The digits in the rightmost column are multiplied to produce a product (24), which the individual doing the multiplication must keep in mind. The ones-place (rightmost) digit of the product (4 in the case of FIG. 1A) is placed in columnar fashion beneath the line and the tens-place or left-most digit is placed above the second column of numbers being multiplied. In the case of the single-digit numbers being multiplied in FIG. 1A, there are no digits in the second column, so the tens-place digit placed above that column is simply “added” together with assumed zeroes in the second column to produce a sum (2 in the case of FIG. 1A), which is then placed in columnar fashion beneath the line to produce the result of the multiplication, namely, 24.

FIG. 1B shows in diagrammatic form the multiplication technique described above with reference to FIG. 1A. In FIG. 1B, the work area is divided into a Multiplication Zone, a Carrying Zone and an Answer Zone, which correspond to and, once drawn, facilitate the steps involved in the multiplication technique.

Turning to FIGS. 2A and 2B, the conventional technique for performing multiplication is demonstrated for two double-digit numbers. Once arranged in columnar fashion in the Multiplication Zone as shown in FIG. 2B, the ones-place (rightmost) digits (3 and 8) are multiplied to produce a product (24). The ones-place digit (4) of the product is placed in columnar fashion in the first column of the Addition Zone beneath the line at the bottom of the Multiplication Zone. The tens-place digit (2) of the product is placed in the Carrying Zone above the second column of digits in the Multiplication Zone. Next, the ones-place digit (8) in the lower number and the tens-place digit (1) of the upper number are multiplied to produce a product (8) that must be kept in mind and added to the number (2) in the Carrying Zone to produce a sum (10). The ones-place digit (0) of that sum is placed in the second column in the Addition Zone, and the tens-place digit (1) of that product is placed in the third column of the Carrying Zone. There are no digits in the third column of the Multiplication Zone, so the tens-place digit (1) placed above that is simply “added” to assumed zeroes in the third column of the Multiplication Zone to produce a sum (1), which is then placed in the third column of the Addition Zone beneath the line to produce the result (104) of the first step of the multiplication.

Next, the tens-place digit (5) of the lower number and the ones-place digit (3) of the upper number are multiplied to produce a product (15). The ones-place digit (5) of the product is then placed in the second column of the Addition Zone below the second digit (0) of the prior number (104) in the Addition Zone. The tens-place digit (1) of the product is then placed in the Carrying Zone above the second column in the Multiplication Zone. At the same time, the prior tens-place digit (2) in the Carrying Zone is crossed out so as not to confuse the new tens-place digit (1) with the prior tens-place digit. Next, the tens-place digit (5) of the lower number and the tens-place digit (1) of the upper number are multiplied to produce a product (5), which when added to the new tens-place digit (1) in the Carrying Zone totals to 6. That result is placed in the third column of the Addition Zone. A line is drawn at the bottom of the Addition Zone, and the numbers in the Addition Zone (104 and 65) are then totaled to produce a total (754), which is then placed in the Answer Zone and represents the solution to the problem of multiplying 13 and 58 using the conventional technique for performing multiplication.

Turning now to FIGS. 3A-3J, the multiplication of two 5-digit numbers (12122 and 11212) will be carried out using the present system. At the outset, and as shown in FIG. 3A, three zones are displayed (for example, drawn) on the work area, the first being the Addition Zone containing a top row, a bottom row and enough space for additional rows. The Addition Zone is also divided into a number of columns corresponding to the number of digits in the numbers being multiplied minus one. In the case of the multiplication operation being commenced in FIG. 3A, there are 10 digits in the numbers being multiplied, so the number of columns in the Addition Zone is 9. Beneath the Addition Zone is the Multiplication Zone, which contains the original numbers to be multiplied. Beneath the Multiplication Zone is the Answer Zone, which consists of one row and, like the Addition Zone, is divided into a number of cells (9) corresponding to the number of digits being multiplied minus one.

FIG. 3B illustrates display \textcircled{1} of the present system. The pivot point indicator is displayed below the first column of digits in the Multiplication Zone. The digits in the first (rightmost) column (2 and 2) are multiplied, and the product (4) is displayed in the first (rightmost) column of the Addition Zone. That column is then summed to produce a total (4), which is displayed in the bottom row of the Addition Zone. The ones-place digit (4) of the sum is then displayed in the first (rightmost) cell in the Answer Zone. (As will be illustrated in some of the later displays described below, if the sum had produced a 2-digit number, then the tens-place digit would have been displayed in the second cell (first to the left of the rightmost column) in the top row of the Addition Zone.)

FIG. 3C illustrates display \textcircled{2} of the present system. As shown, the pivot point indicator is now displayed between the first and second columns of digits in the Multiplication Zone in the Multiplication Zone. The digits in the second column (2 and 1) and the digits in the first column (2 and 2) are cross-multiplied, and the respective products (4 and 2) are then displayed in the second column of the Addition Zone. The numbers in that column are then added to produce a sum (6), which is displayed in the bottom row of the Addition Zone. The ones-place digit (6) is then displayed in the second cell in the Answer Zone.

FIG. 3D illustrates display \textcircled{3} of the present system. As shown, the pivot point indicator is now displayed below the second column of digits in the Multiplication Zone. The digits in the second column (2 and 1) at the pivot point indicator are multiplied first, and the product (2) is displayed in the third column of the Addition Zone. The digits in the column just to the left of the pivot point indicator (1 and 2) and the digits in the column just to the right of the pivot point indicator (2 and 2) are then cross-multiplied, and the respective products (2 and 4) are displayed in the third column of the Addition Zone. The numbers in the third column are then added to produce a sum (8), which is displayed in the bottom row of the Addition Zone. The ones-place digit (8) is then displayed in the third cell of the Answer Zone.

FIG. 3E illustrates display \textcircled{4} of the present system. As shown, the pivot point indicator is now displayed between the second and third columns of digits in the Multiplication Zone. The digits in the third column (1 and 2) and the digits in the second column (2 and 1) are cross-multiplied, and the respective products (1 and 4) are then displayed in the fourth column of the Addition Zone. As further shown in FIG. 3E, the digits in the fourth column (2 and 1) and digits in the first column (2 and 2) are cross-multiplied, and the respective products (4 and 2) are then displayed in the fourth column of the Addition Zone. The numbers in the fourth column are then added to produce a sum (11), which is displayed in the bottom row of the Addition Zone. The ones-place digit (1) is then displayed in the fourth cell in the Answer Zone, while the tens-place digit (1) is displayed in the top row of the fifth column of the Addition Zone, as shown in FIG. 3E.

The cross-multiplication displays depicted in FIG. 3E are important to the understanding of the present system for performing multiplication. The cross-multiplication is carried out on as many columns of digits in the Multiplication Zone as possible on either side of the pivot point indicator until no further cross-multiplications are possible, even though there may be a column remaining on the left or on the right that cannot be paired and therefore cannot participate in the cross-multiplication portion of a display.

FIG. 3F illustrates display \textcircled{5} of the present system. As shown, the pivot point indicator is now displayed below the third column of digits in the Multiplication Zone. The digits in the third column (1 and 2) at the pivot point indicator are multiplied first, and the product (2) is displayed in the fifth column of the Addition Zone. The digits in the column just to the left of the pivot point indicator (2 and 1) and the digits in the column just to the right of the pivot point indicator (2 and 1) are then cross-multiplied, and the respective products (2 and 2) are also displayed in the fifth column of the Addition Zone. There are more cross-multiplications possible to carry out in the Multiplication Zone on either side of the pivot point indicator, and as further shown in FIG. 3F, the digits in the fifth column (1 and 1) and digits in the first column (2 and 2) are cross-multiplied, and the respective products (2 and 2) are then displayed in the fourth column of the Addition Zone. The numbers in the fourth column are then added to produce a sum (11), which is displayed in the bottom row of the Addition Zone. The ones-place digit (1) is then displayed in the fifth cell of the Answer Zone, while the tens-place digit (1) is displayed in the top row of the sixth column of the Addition Zone, as shown in FIG. 3F.

FIG. 3G illustrates display \textcircled{6} of the present system. As shown, the pivot point indicator is now displayed between the third and fourth columns of digits in the Multiplication Zone. The ellipses that illustrated the various cross-multiplications in the previous figures have been omitted to simplify this and subsequent figures, but the same cross-multiplication process applies. Accordingly, the digits in the fourth column (2 and 1) and the digits in the third column (1 and 2) are cross-multiplied, and the respective products (4 and 1) are then displayed in the sixth column of the Addition Zone. The digits in the fifth column (1 and 1) and digits in the second column (2 and 1) are cross-multiplied, and the respective products (1 and 2) are then displayed in the sixth column of the Addition Zone. No further cross-multiplications are possible, so the numbers in the sixth column are then added to produce a sum (9), which is displayed in the bottom row of the Addition Zone. The ones-place digit (9) is then displayed in the sixth cell of the Answer Zone. There is no tens-place digit to be displayed in the top row of the seventh column of the Addition Zone in FIG. 3G.

FIG. 3H illustrates display \textcircled{7} of the present system. As shown, the pivot point indicator is now displayed below the fifth column of digits in the Multiplication Zone. The digits in the fifth column (2 and 1) at the pivot point indicator are multiplied first, and the product (2) is displayed in the seventh column of the Addition Zone. The digits in the column just to the left of the pivot point indicator (1 and 1) and the digits in the column just to the right of the pivot point indicator (1 and 2) are then cross-multiplied, and the respective products (2 and 1) are also displayed in the seventh column of the Addition Zone. No further cross-multiplications are possible, so the numbers in the seventh column are then added to produce a sum (5), which is displayed in the bottom row of the Addition Zone. The ones-place digit (5) is then displayed in the seventh cell of the Answer Zone. There is no tens-place digit to be displayed in the top row of the eighth column of the Addition Zone in FIG. 3H.

FIG. 3I illustrates display \textcircled{8} of the present system. As shown, the pivot point indicator is now displayed between the fourth and fifth columns of digits in the Multiplication Zone. The digits in the fifth column (1 and 1) and the digits in the fourth column (2 and 1) are cross-multiplied, and the respective products (1 and 2) are then displayed in the eighth column of the Addition Zone. No further cross-multiplications are possible, so the numbers in the eighth column are then added to produce a sum (3), which is displayed in the bottom row of the Addition Zone. The ones-place digit (3) is then displayed in the eighth cell of the Answer Zone. There is no tens-place digit to be displayed in the top row of the ninth column of the Addition Zone in FIG. 3I.

FIG. 3J illustrates display \textcircled{9} of the present system. As shown, the pivot point indicator is now displayed below the fifth column of digits in the Multiplication Zone. The digits in the fifth column (1 and 1) at the pivot point indicator are multiplied, and the product (1) is displayed in the ninth column of the Addition Zone. That column is then summed to produce a total (1), which is displayed in the bottom row of the Addition Zone. The ones-place digit (1) is displayed in the ninth (left-most) cell of the Answer Zone in FIG. 3J.

The sequence of digits in the Answer Zone of FIG. 3J (135911864) is the solution to the problem of multiplying 12122 and 11212 using the present system for performing multiplication.

FIGS. 4A-4J illustrate the multiplication on the work area of two 5-digit numbers, made up of larger numbers than those in FIGS. 3A-3J, in order to demonstrate the present system using numbers whose products when multiplied are larger double-digit numbers. The 5-digit numbers being multiplied in FIGS. 4A-4J are 54321 and 56789. At the outset, and as shown in FIG. 4A, the Addition Zone, the Multiplication Zone and the Answer Zone are drawn. The Addition Zone contains a top row, a bottom row, enough space for additional rows, and nine columns, which corresponds to the number of digits in the numbers being multiplied minus one. Beneath the Addition Zone is the Multiplication Zone, which contains the original numbers to be multiplied. Beneath the Multiplication Zone is the Answer Zone, which consists of one row and, like the Addition Zone, is divided into 9 columns.

FIG. 4B illustrates display \textcircled{1} of the present system. The pivot point indicator is displayed below the first column of digits in the Multiplication Zone to be multiplied. The digits in the first (rightmost) column (1 and 9) are multiplied, and the product (9) is displayed in the first (rightmost) column of the Addition Zone. That column is then summed to produce a total (9), which is displayed in the bottom row of the Addition Zone. The ones-place digit (9) is then displayed in the first (rightmost) cell of the Answer Zone.

FIG. 4C illustrates display \textcircled{2} of the present system. As shown, the pivot point indicator is now displayed between the first and second columns of digits in the Multiplication Zone. The digits in the second column (2 and 8) and the digits in the first column (2 and 1) are cross-multiplied, and the respective products (18 and 8) are then displayed in the second column of the Addition Zone. The numbers in that column are then added to produce a sum (26), which is displayed in the bottom row of the Addition Zone. The ones-place digit (6) is then displayed in the second cell of the Answer Zone, while the tens-place digit (2) is displayed in the top row of the third column of the Addition Zone in FIG. 4C.

FIG. 4D illustrates display \textcircled{3} of the present system. As shown, the pivot point indicator is now displayed below the second column of digits in the Multiplication Zone. The digits in the second column (2 and 8) at the pivot point indicator are multiplied first, and the product (16) is displayed in the third column of the Addition Zone. The digits in the column just to the left of the pivot point indicator (3 and 7) and the digits in the column just to the right of the pivot point indicator (1 and 9) are then cross-multiplied, and the respective products (27 and 7) are displayed in the third column of the Addition Zone. The numbers in the third column are then added to produce a sum (52), which is displayed in the bottom row of the Addition Zone. The ones-place digit (2) is then displayed in the third cell of the Answer Zone, while the tens-place digit (5) is displayed in the top row of the fourth column of the Addition Zone in FIG. 4D.

FIG. 4E illustrates display \textcircled{4} of the present system. As shown, the pivot point indicator is now displayed between the second and third columns of digits in the Multiplication Zone. The digits in the third column (3 and 7) and the digits in the second column (2 and 8) are cross-multiplied, and the respective products (24 and 14) are then displayed in the fourth column of the Addition Zone. As further shown in FIG. 4E, the digits in the fourth column (4 and 6) and digits in the first column (1 and 9) are cross-multiplied, and the respective products (36 and 6) are then displayed in the fourth column of the Addition Zone. The numbers in the fourth column are then added to produce a sum (85), which is displayed in the bottom row of the Addition Zone. The ones-place digit (5) is then displayed in the fourth cell of the Answer Zone, while the tens-place digit (8) is displayed in the top row of the fifth column of the Addition Zone, as shown in FIG. 4E.

FIG. 4F illustrates display \textcircled{5} of the present system. As shown, the pivot point indicator is now displayed below the third column of digits in the Multiplication Zone. The digits in the third column (3 and 7) at the pivot point indicator are multiplied first, and the product (21) is displayed in the fifth column of the Addition Zone. The digits in the column just to the left of the pivot point indicator (4 and 6) and the digits in the column just to the right of the pivot point indicator (2 and 8) are then cross-multiplied, and the respective products (32 and 12) are also displayed in the fifth column of the Addition Zone. There are more cross-multiplications possible to carry out on either side of the pivot point indicator, and as further shown in FIG. 4F, the digits in the fifth column (5 and 5) and digits in the first column (1 and 9) are cross-multiplied, and the respective products (45 and 5) are then displayed in the fourth column of the Addition Zone. The numbers in the fourth column are then added to produce a sum (123), which is displayed in the bottom row of the Addition Zone. The ones-place digit (3) is then displayed in the fifth cell of the Answer Zone, while the second and hundreds-place digits (12) are together displayed in the top row of the sixth column of the Addition Zone, as shown in FIG. 4F.

FIG. 4G illustrates display \textcircled{6} of the present system. As shown, the pivot point indicator is now displayed between the third and fourth columns of digits in the Multiplication Zone. The ellipses that illustrated the various cross-multiplications in the previous figures have been omitted to simplify this and subsequent figures, but the same cross-multiplication process applies. Accordingly, the digits in the fourth column (4 and 6) and the digits in the third column (3 and 7) are cross-multiplied, and the respective products (28 and 18) are then displayed in the sixth column of the Addition Zone. The digits in the fifth column (5 and 5) and digits in the second column (2 and 8) are cross-multiplied, and the respective products (40 and 10) are then displayed in the sixth column of the Addition Zone. No further cross-multiplications are possible, so the numbers in the sixth column are then added to produce a sum (108), which is displayed in the bottom row of the Addition Zone. The ones-place digit (8) is then displayed in the sixth cell of the Answer Zone, while the second and hundreds-place digits (10) are together displayed in the top row of the seventh column of the Addition Zone, as shown in FIG. 4G.

FIG. 4H illustrates display \textcircled{7} of the present system. As shown, the pivot point indicator is now displayed below the fifth column of digits in the Multiplication Zone. The digits in the fifth column (4 and 6) at the pivot point indicator are multiplied first, and the product (24) is displayed in the seventh column of the Addition Zone. The digits in the column just to the left of the pivot point indicator (5 and 5) and the digits in the column just to the right of the pivot point indicator (3 and 7) are then cross-multiplied, and the respective products (35 and 15) are also displayed in the seventh column of the Addition Zone. No further cross-multiplications are possible, so the numbers in the seventh column are then added to produce a sum (84), which is displayed in the bottom row of the Addition Zone. The ones-place digit (4) is then displayed in the seventh cell of the Answer Zone, while the tens-place digit (8) is displayed in the top row of the eighth column of the Addition Zone in FIG. 4H.

FIG. 4I illustrates display \textcircled{8} of the present system. As shown, the pivot point indicator is now displayed between the fourth and fifth columns of digits in the Multiplication Zone. The digits in the fifth column (5 and 5) and the digits in the fourth column (4 and 6) are cross-multiplied, and the respective products (30 and 20) are then displayed in the eighth column of the Addition Zone. No further cross-multiplications are possible, so the numbers in the eighth column are then added to produce a sum (58), which is displayed in the bottom row of the Addition Zone. The ones-place digit (8) is then displayed in the eighth cell of the Answer Zone, while the tens-place digit (5) is displayed in the top row of the ninth column of the Addition Zone in FIG. 4I.

FIG. 4J illustrates display \textcircled{9} of the present system. As shown, the pivot point indicator is now displayed below the fifth column of digits in the Multiplication Zone. The digits in the fifth column (5 and 5) at the pivot point indicator are multiplied, and the product (25) is displayed in the ninth column of the Addition Zone. No cross-multiplications are possible to perform, so that column is then summed to produce a total (30), which is displayed in the bottom row of the Addition Zone and which is also displayed in the ninth (left-most) cell of the Answer Zone.

The sequence of digits in the Answer Zone of FIG. 4J (3084835269) is the result of multiplying 54321 and 56789 using the present system for performing multiplication.

FIGS. 5A-5N are diagrams depicting the progression of displays associated with the present system for performing the multiplication of two 7-digit numbers (1212122 and 2121211). For brevity, the displays associated with that multiplication operation will not be described in this text, since the displays are substantially similar to those carried out in the multiplication operations illustrated in FIGS. 3A-3J and FIGS. 4A-4J, and can be readily understood with reference to FIGS. 5A-5N after having understood the previous figures and accompanying text.

In the present system, where the numbers to be multiplied are of different length, then the smaller number should be preceded by zeroes such that both numbers are of the same length when arranged in the Multiplication Zone. For example, to multiply 78923 with 4567, the numbers should be arranged in the Multiplication Zone as set forth in FIG. 4A.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in each figure.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

FIG. 6A presents a front view of a math learning frame and system in an embodiment disclosed herein. The frame, for short, is a square or rectangular device intended to be placed upon a page of a book or looseleaf handout having a printed multiplication problem for resolution therewith. It is composed of four primary members 20A, 20B, 20C, 20D and two transverse members 24, 25; additionally, the it has three system helpers, namely, a template 21, a column locator 22 and a pivot point indicator 23.

The frame's four primary members are manufactured from wood, metals or preferably of durable plastic materials. It is constructed by connecting the various joints together using a flexible protrusion on a first member matching a just smaller cavity on second member, nails, screws, glue, welding, solder, brazing, combinations of the foregoing or similar modalities. The left member 20A has a first end forming a first joint to an end of the top member 20C and the left member has a second end forming a second joint to another end of the bottom member 20D. The right member 20B has a third end forming a third joint with another end of the top member 20C and the right member 20B has a fourth end forming a fourth joint with another end of the bottom member 20D thereby completing the frame outer perimeter.

The two transverse members 24 and 25 are similar connected between the left member 20A and the right member 20B. Between the two members 24, 25, is a space that permits a student to view the math problem (multiplication zone) that is being worked upon. A user places a template 21 upon the math problem and uses the various cut curves within the template 21 to create rounded curves over the various parts of the problem as described previously in the specification (or hovers over using clear plastic to read and calculate mentally). The template typically has a completed oval, ellipse, generic curve or preferably a stunted set of curves to exercise a user's hand eye coordination by compelling the student to complete a first portion of the curve with the template and the second portion of the curve being worked upon without the template.

In order to further assist the student in deciding what column is being worked upon, there is a column indicator 22 that abuts the transverse member 24 by sliding on one of: a) a top flat surface (basic) of the transverse member 24, b) a depression in the top surface of the transverse member 24, or c) alternatively slides within a hollowed out portion of transverse member 24.

Similarly, in order to further assist the student in deciding where to place the template 21, there is a pivot point indicator 23 that abuts the transverse member 25 by sliding on one of: a) a top flat surface (basic) of transverse member 25, b) a depression in the top surface of the transverse member 25, or c) alternatively slides within a hollowed out portion of transverse member 25. The pivot point indicator has an arrowhead that directly points to the position of the particular mathematical step.

FIG. 6B presents a top (or bottom) view of a transverse member 24, 25 (or bottom view of member 20C) of the math learning frame and system in an embodiment disclosed herein having three surface options. The figure represents either of a depression for the abutting of corresponding curved end of template 21, column locator 22, pivot point indicator 23, or a hollow member 24, 25, member 20C, having a narrow longitudinal slot for the insertion of an integral slide of template 21, locator 22, or pivot point indicator 23 as shown in the drawing of FIG. 6A. The flat surface option of the top or bottom surfaces is not shown but understood.

FIG. 6C presents a front view of a column locator of the math learning frame and system in an embodiment disclosed herein. The column locator 22 is a longitudinal member made from plastic or other materials. It is typically rectangular as it is used to circumscribe a column for assisting the user in adding the numerals written therein. The column locator 22 has four sides (22A, 22B, 22C, 22D) and two transverse members (22E, 22F) integrally formed as a single device. It has a left side 22A, a right side 22B opposite the left side, a top side 22C and a bottom side 22D opposite the top side; thus, the four sides form a space that in this example is rectangular. A first transverse member 22E and a second transverse member 22F complete the device and both span the space between the left side 22A and the right side 22B as well as being parallel to the top side 22C and the bottom side 22D. With the addition of the two transverse members 22E, 22F there are three separate spaces subdivided by the transverse members forming a top space, a bottom space and an intermediate space. The top space is for carries, the intermediate space is for multiplied numbers and the bottom space is for sum of the column on the looseleaf or book page.

FIG. 7A presents a closeup front view of column locator bottom of the math learning frame and system in an embodiment disclosed herein. Here the column locator 22 has an integral protrusion 22H for riding within a hollowed out portion of transverse member 24. The integral protrusion is connected to the bottom side 22D of column locator 22 through an integral narrow neck 22G.

FIG. 7AA presents a closeup front view of an alternative column locator top and or bottom portion (template 21 top portion or pivot point indicator 23 bottom portion) of the math learning frame and system in an embodiment disclosed herein. Here 21, 22, 23 have an integral rounded portion which would be the top portion of template 21, bottom portion and or top portion of column locator 22 and bottom portion of pivot point indicator 23.

FIG. 7B presents a closeup side view of a column locator bottom of the math learning frame and system in an embodiment disclosed herein. Here the column locator 22 has an integral protrusion 22H for riding within a hollowed out portion of transverse member 24 that integrates with the bottom side 22D of the column locator using a narrow integral neck 22G.

FIG. 7BB presents a closeup side view of an alternative column locator bottom of the math learning frame and system in an embodiment disclosed herein. Here the template 21 top, column locator 22 top and or bottom sides and pivot point indicator 23 bottom, have an integral flat portion for sliding upon a bottom of transverse member 24, top side of transverse member 24 or bottom of primary member 20C or top of transverse member 25.

FIG. 7C presents a front view of a pivot point indicator of the math learning frame and system in an embodiment disclosed herein. Here the pivot point indicator 23 has an integral protrusion 23D for riding within a hollowed out top portion of transverse member 25. The pivot point indicator 23 has an integral arrow 23A at top that integrates with a central portion 23B having a number symbol 23C thereon. The central portion 23B integrates with a raised protrusion 23D through a narrow neck 23E that integrates with the bottom of the central portion 23B.

FIG. 7D presents a side view of a pivot point indicator of the math learning frame and system in an embodiment disclosed herein. Here the pivot point indicator 23 has an integral protrusion 23D for riding within a hollowed out top portion of transverse member 25. The pivot point indicator 23 has an integral arrow 23A at top that integrates with a central portion 23B having a number symbol 23C thereon. The central portion 23B integrates with a raised protrusion 23D through a narrow neck 23E that integrates with the bottom of the central portion 23B.

FIG. 8A presents a front view of a criss-cross template for odds of the math learning frame and system in an embodiment disclosed herein. The template 21 has rounded perforations or cutouts that represent the various criss-cross patterns that are created when the user marks the page (using the perforations or cutouts) of the book or working paper whereupon the multiplication is taking place. The criss-cross patterns can also be considered a butterfly pattern. Alternatively, the perforations or cutouts shown are instead printed curves on the template 21 body; as the template is clear the student slides the template on its upper slide against the bottom of transverse member 24 stopping it above the particular set of numbers indicated by the pivot point indicator 23. The student computes the multiplication based upon the printed curves as appropriate.

FIG. 8B presents a front view of a criss-cross template for evens of the math learning frame and system in an embodiment disclosed herein. The template 21 has rounded perforations or cutouts that represent the various criss-cross patterns that are created when the user marks the page (using the perforations or cutouts) of the book or working paper whereupon the multiplication is taking place. The criss-cross patterns can also be considered a butterfly pattern. Alternatively, the perforations or cutouts shown are instead printed curves on the template 21 body; as the template is clear the student slides the template on its upper slide against the bottom of transverse member 24 stopping it above the particular set of numbers indicated by the pivot point indicator 23. The student computes the multiplication based upon the printed curves as appropriate.

Either template 21 has a top edge that is either flat, rounded or provided with a top raised protrusion that integrates with the top portion of the rectangular template; these are for sliding with a bottom flat surface of the first transverse member 24, for sliding against a bottom depression in the bottom surface of the first transverse member 24, or for sliding within a hollowed out portion of the bottom of transverse member 24 having a cutout slot as shown in FIG. 6B.

Similarly the column locator 22 has a top and bottom that are flat, rounded or provided with raised protrusions that integrate with the top and bottom portions of the column locator 22. These are for sliding with a bottom flat surface of the primary member 20A (also top of 24), for sliding with a bottom depression in the bottom surface of the primary member 20A (also top of 24), or for sliding within a hollowed out bottom portion of the primary member 20A (also top of 24) having a cutout slot as shown in FIG. 6B.

Similarly the pivot point indicator 23 has a bottom that is flat, rounded or provided with a raised protrusion that integrates with the bottom portion of the pivot point indicator 23. These are for sliding on a top flat surface of the transverse member 25, for sliding thereon with a top depression in the top surface of the transverse member 25, or for sliding within a hollowed out top portion of the transverse member 25 having a cutout slot as shown in FIG. 6B.

FIG. 9 presents a flowchart of the process by which a teacher instructs students in how to utilize the math learning frame and system in an embodiment disclosed herein. The process begins 101 by the teacher discussing each of the pieces of the math learning frame and system templates 21, column locator 22, and pivot point indicator 23 at step 102. The teacher instructs the pupils to test 103 the motion of each against the frame 20. At this point a problem is provided 104 on the chalkboard or spoken out loud by the teacher so that each student is instructed to write it down in the multiplication zone. The teacher asks the students 105 what step are we in the process the first, second, third and so on (or they will determine the answer without her question when they are solving problems independently) or she will tell them.

If the last step is completed the process ends; if not, then the teacher instructs 106 the pupils to move the pivot point indicator under the particular step position of the multiplication zone; then, an instruction is given to move 107 the column locator about the particular step column in the addition zone to highlight the problem to be summed. The teacher tells the students to circumscribe 108 the numbers to be multiplied in the multiplication zone by using the appropriate template (in the first case odd, then even, then odd and so forth) and then multiplying 109 the various sets of numbers in the multiplication zone and writing 110 the answer in the appropriate portion of the highlighted column, then the sum of the individual column at its bottom and in the answer zone (without a carried number here). Next, a determination is made by the student if any numbers are to be carried over 111. If so, they are placed 112 in the next place carry cell of the addition zone. If no the process repeats to step 105 until all of the multiplications have occurred as described previously in the specification.

The process steps 105 to 111 (and 112 as needed) are repeated again and again until the various steps complete the multiplication. The positions of the pivot point indicator are described to the students as starting upon a first cell then alternating between cells for even template multiplications and then upon a next cell for odd multiplications, then even as needed and so forth until all columns have had the position point indicator underneath the last columns multiplication zone cell or between cells as appropriate.

It should be understood that the step of Scribe the Numbers 108 means either of using a perforated template 21 to highlight the numbers with written curves or alternatively analyze them mentally with printed curves of the template through the clear plastic of the template 21. Thus, each curve formed on the template circumscribes a duo of numbers that are analyzed and multiplied until completed.

It should be understood that FIG. 7AA represents a side closeup view of an end of the template 21, column locator 22, and pivot point indicator 23. In this regard, it should be understood that the drawing has the rounded portion at bottom in the figure. As the template 21 is designed to have the flat, rounded or raised protrusion at top it is understood that the figure would be inverted in that case or flipped as appropriate. Similarly, as the column locator 22 has flat, rounded or raised protrusion at top or bottom, the closeup figure represents the bottom rounded versions and to get the top version the figure needs to be flipped or inverted. For the pivot point indicator 23 there is only a flat, rounded or raised protrusion bottom version so FIG. 7AA is appropriate for the rounded design. It should further be understood that the flat versions for 21, 22, 23 are not shown as these are easily understood and that the raised protrusion type would be duplicated as necessary from the drawings. FIG. 6C column locator 22 has another integral protrusion 22J for riding within a hollowed out portion of top member 20C. The integral protrusion 22J is connected to the top side 22C of column locator 22 through an integral narrow neck 22I.

Finally, templates 21 are inserted within the slot of FIG. 6B either by forcing the protrusion therein or that the longitudinal slot has a large opening at one or both ends to alternate the removal and entry of one or the other template therein. Alternatively, one template is always connected and one is free without an integral protrusion. As a final alternative there is only one template, but the curves are much more broken permitting both even and odds to be printed together thereon or perforated on a single template. Also, FIG. 6A shows that there are three spaces one between top member 20C and transverse member 24 (for addition zone of book page or paper), one between transverse members 24, 25 (for multiplication zone of book page or paper), and one between transverse member 25 and the bottom member 20D (for answer zone of book page or paper), and the appropriate members 20A, 20B.

The above-described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention not be limited to the particular embodiments disclosed as the best mode contemplated for carrying out this invention, but that the invention will include all the embodiments falling within the scope of the appended claims.

What is claimed is:

1. A system for multiplying two numbers comprising:
a frame having:
a top member opposite a bottom member;
a left member opposite a right member;
wherein the left member is attached to the top member at a left member end and the left member is attached to the bottom member at another end of the left member; and
wherein the right member is attached to the top member at a right member end and the right member is attached to the bottom member at another end of the left member.

2. The system for multiplying two numbers of claim 1, further comprising:
a first transverse member attached between the left and right members; and
a second transverse member attached between the left and right members.

3. The system for multiplying two numbers of claim 2, further comprising:
a multiplication viewing space between the first and second transverse members.

4. The system for multiplying two numbers of claim 1, further comprising:
a multiplication viewing space between the top and bottom members.

5. The system for multiplying two numbers of claim 1, further comprising:
a pivot point indicator associated with the frame.

6. The system for multiplying two numbers of claim 5, wherein the pivot point indicator movably abuts the frame.

7. The system for multiplying two numbers of claim 6, wherein the pivot point indicator is movably attached to the frame.

8. The system for multiplying two numbers of claim 6, wherein the pivot point indicator is movably attached to the frame at a transverse member between the left and right member.

9. The system for multiplying two numbers of claim 1, further comprising:
a column locator associated with the frame.

10. The system for multiplying two numbers of claim 9, wherein the column locator movably abuts the frame.

11. The system for multiplying two numbers of claim 10, wherein the column locator is movably attached to the frame.

12. The system for multiplying two numbers of claim 11, wherein the column locator is movably attached to the frame at a transverse member between the left and right member.

13. The system for multiplying two numbers of claim 1, further comprising:
a criss-cross template movably associated with the frame.

14. The system for multiplying two numbers of claim 13, further comprising:
a first diagonal shape cutout of the template material; and
a second diagonal shape cutout of the template material forming a diagonal shape that starts at an vertex of a hypothetical quadrilateral not part of the first diagonal.

15. The system for multiplying two numbers of claim 13, wherein the criss-cross template corresponds to vertices of an odd quadrilateral for a multiplication zone of the frame.

16. The system for multiplying two numbers of claim 13, wherein the criss-cross template corresponds to vertices of an even quadrilateral for a multiplication zone of the frame.

17. A method of performing multiplication of two numbers comprising the steps of:
positioning a multiplication frame about a work page;
determining what step in a multiplication process one is at;
moving a pivot point indicator associated with a multiplication frame underneath a multiplication zone position associated with the determined step.

18. The method of performing multiplication of two numbers of claim 17, comprising the step of:
situating a column locator about the particular column of an addition zone of the work page.

19. The method of performing multiplication of two numbers of claim 18, comprising the step of:
performing a criss-cross multiplication with a template about the multiplication zone position and scribing the results in an addition zone of the work page.

20. The method of performing multiplication of two numbers of claim 19, comprising the steps of:
summing the results of the addition zone and placing the results in a summary cell of the addition zone and in the answer zone along with carrying any carry units to the carry cell of the next column top in a series;
until there are no more multiplication zone units to be evaluated, repeating the steps of:
positioning a multiplication frame about a work page;
determining what step in a multiplication process one is at;
moving a pivot point indicator associated with a multiplication frame underneath a multiplication zone position associated with the determined step;
situating a column locator about the particular column of an addition zone of the work pages;
performing a criss-cross multiplication with a template about the multiplication zone position and scribing the results in an addition zone of the work page; and
summing the results of the addition zone and placing the results in a summary cell of the addition zone and in the answer zone along with carrying any carry units to the carry cell of the next column top in a series.
